(19) United States
(12) Patent Application Publication
(10) Pub. No.: US 2016/0018720 A1
(43) Pub. Date: Jan. 21, 2016

(54) MAGNETIC SHIELDING BETWEEN VOICE COIL MOTORS IN A DUAL-APERTURE CAMERA

(71) Applicants: GIL BACHAR, Tel-Aviv (IL); EPHRAIM GOLDENBERG, Ashdod (IL); GAL SHABTAY, Tel Aviv (IL)

(72) Inventors: GIL BACHAR, Tel-Aviv (IL); EPHRAIM GOLDENBERG, Ashdod (IL); GAL SHABTAY, Tel Aviv (IL)

(21) Appl. No.: 14/365,718

(22) PCT Filed: Jun. 12, 2014
(86) PCT No.: PCT/IB2014/062181

§ 371 Date: Jun. 16, 2014

Related U.S. Application Data
(60) Provisional application No. 61/941,616, filed on Feb. 19, 2014.

(51) Int. Cl. G03B 13/36; G02B 27/00; G02B 7/09; H04N 5/247; H04N 5/225

(52) U.S. Cl. CPC G03B 13/36; H04N 5/247; H04N 5/2257; G02B 7/09; G02B 27/0006

(57) ABSTRACT

A dual-aperture camera with two camera modules that include each a voice coil motor (VCM) actuator coupled to respective lens barrels and a magnetic shield plate positioned tightly between the two camera modules. The shield plate reduces or even prevents magnetic interference during operation of each VCM actuator to move its respective lens barrel. In some embodiments, the magnetic shield plate is rectangular and has a length and a height that are not larger than the length and height of either camera module. The magnetic shield plate may be made of any ferromagnetic material. Exemplarily, it may be made of grey iron or FeCo.

### CROSS REFERENCE TO RELATED APPLICATIONS

This application is related to and claims priority from U.S. Provisional Patent Application No. 61/941,616 having the same title and filed Feb. 12, 2014, which is incorporated herein by reference in its entirety.

### FIELD

Embodiments disclosed herein relate in general to magnetic shielding of voice coil motors (VCM) and in particular to magnetic shielding of VCMs used in miniature dual-optical module (“dual-aperture”) cameras.

### BACKGROUND

A compact (miniature) dual-aperture camera (or simply “dual-camera”) as e.g. in a smart-phone, can be used in conjunction with appropriate computational photography algorithms for several purposes. These include achieving advanced digital zoom, lowering total module height while keeping high performance, improving low-light performance and creating depth maps. In order to simplify the computational photography algorithms and thus reduce time and errors, it is required that the two cameras be set as closely proximate as possible. In compact camera modules, the most ubiquitous form of achieving focus and/or optical image stabilization (OIS) is by actuating (shifting) the camera lens with respect to the camera detector. The most common actuator type in such cameras is the voice coil motor (VCM). A VCM actuator includes coils, fixed (also referred to as “permanent” or “hard”) magnets and springs. When current is driven through a coil, an electro-magnetic (EM) Lorentz force is applied on it by the magnets' magnetic field and the lens module changes position.

In dual-aperture photography, two camera modules enable taking two images of the same scene simultaneously. Each camera may include a VCM (or another magnetic) actuator. When using VCM actuators, the two VCM actuators are positioned in close proximity In some embodiments, the two camera modules may have different optical elements (e.g. lenses). Each VCM actuator needs then to actuate its respective lens according to the optical demands. Each VCM actuator needs to operate separately, preferably as if it was not coupled magnetically to the other VCM actuator (i.e. as if it was a standalone module).

Two VCM actuators in close proximity may interfere with each other's magnetic field and may not work properly. This interference limits the minimal distance between the actuators (or requires unique magnetic structures and changes to the VCM). A small distance is advantageous for minimizing camera footprint and for simplifying computational photography algorithms and calculations, because it results in smaller parallax.

Magnetic shield caps for use with digital camera VCM actuators are described for example in US patent applications 20130044382 and 20130242181 by Phoon et al. Phoon's main concern is with the manufacturing process of VCM camera modules, a process in which two-dimensional arrays of such modules are batch-fabricated while glued by adhesive on a substrate. There is no suggestion in Phoon that his caps may be used in dual-aperture cameras. Requirements for magnetic shielding during operation (use) of a dual-aperture camera are different from those during VCM camera module manufacturing. Use of Phoon's magnetically shielded VCM camera modules in a dual-aperture camera would disadvantageously increase the camera footprint and would require additional steps and materials during camera module manufacturing, thereby increasing cost. Small footprint and low cost are two very important requirements in a cell-phone (and in particular smart-phone) camera.

Clearly, the known art does not provide a satisfactory solution to the problem of magnetic interference from permanent magnets in dual-aperture thin cameras.

### SUMMARY

The present inventors have discovered an elegant, cost effective and footprint-advantageous solution to magnetically shield two VCM camera modules (also referred to herein as “VCM actuators”) from each other during operation of a dual-aperture digital camera. The solution is based on a thin magnetic shield plate positioned between the two VCM actuators. The plate is of dimensions (thickness, length and height) that do not substantially change either the footprint or the height of a non-magnetically shield dual-aperture camera, yet provides the necessary magnetic shielding to block all magnetic interference between the two VCM actuators.

In various embodiments, there are disclosed dual-aperture cameras with two VCM actuators shielded magnetically from each other by a magnetic shield plate positioned tightly between camera modules that include the VCM actuators.

In an embodiment there is provided a dual-aperture camera comprising a first camera module including a VCM actuator coupled to a first lens barrel, the first VCM actuator operable to change a position of the first lens barrel in a given direction, a second camera module including a second VCM actuator coupled to a second lens barrel, the second VCM actuator operable to change a position of the second lens module in the given direction, and a magnetic shield plate fixedly positioned between the first and second camera modules, whereby the magnetic shield plate shields magnetically each VCM actuator from magnetic interference by the other VCM actuator during operation.

In an embodiment, the first and second camera modules have identical lengths and heights and the plate has a length and a height no greater than the camera modules length and height. In an embodiment, the first camera module has a larger length and a larger height than the second camera module and the plate has a length and a height no greater than the first camera module length and height. In some embodiments, a camera module length is normally between 5-15 mm and a height is between 3-12 mm In some embodiments, a camera module length is between 8-10 mm and a height is between 3-6 mm. In some embodiments, a camera module length is between 8-10 mm and a height is between 4-8 mm. In some embodiments the magnetic shield plate is rectangular and has a length and a height substantially similar to the length and height of at least one camera module. In some embodiments, the magnetic shield plate is rectangular and has a length and a height that are not larger than the length and height of either camera module. In some embodiments, the magnetic shield plate is made of a ferromagnetic material such as grey iron or FeCo and has a thickness d between 0.4-0.6 mm.

The positioning and use of a magnetic shield between VCM or other magnetic actuators as disclosed herein may be particularly useful in multi-aperture (and in particular in dual-aperture) cameras as disclosed for example in co-owned PCT patent application PCT/IB2013/060356 titled “High resolution thin multi-aperture imaging systems”, U.S. provisional patent application No. 61/861,185 titled “Thin multi-aperture imaging system with auto-focus and methods for using same”, and US provisional patent application No. 61/834,486 titled “Dual aperture zoom digital camera”, all of which are incorporated herein by reference in their entirety.

### BRIEF DESCRIPTION OF THE DRAWINGS

Non-limiting embodiments are herein described, by way of example only, with reference to the accompanying drawings, wherein:

FIG. 1 shows schematically an embodiment of a dual-camera module camera disclosed herein in (a) an isometric view, (b) in a top view (c) in a side view and (d) a cut along line presented in (c);

FIG. 2 shows results of a simulation of a typical known art triangular VCM magnet, with corresponding flux lines trajectories;

FIG. 3 shows simulations of (a) the magnetic field along the coil and (b) of the Lorentz force in four different configurations.

### DETAILED DESCRIPTION

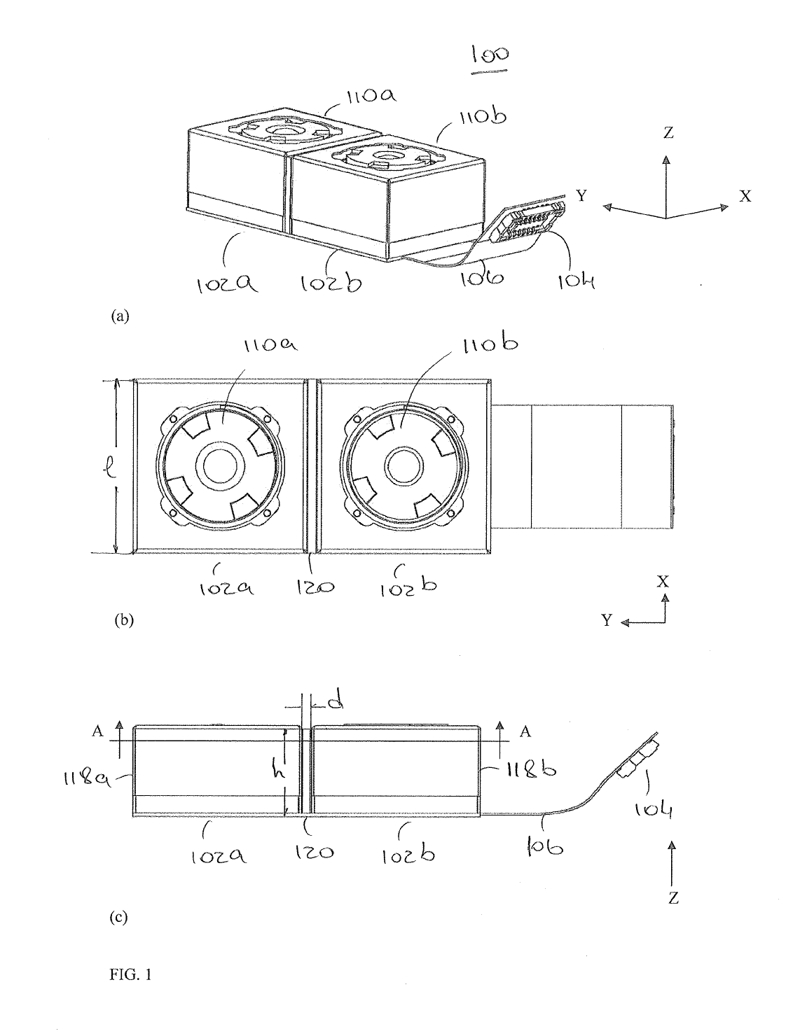

FIG. 1 shows schematically an embodiment of a dual-camera module (dual-aperture) camera numbered 100 in (a) an isometric view, (b) in a top view, (c) in a side view, and (d) in a cut along an A-A line in view (c). Camera 100 comprises two camera modules 102a and 102b connected to a connector 104 through a flexible ribbon 106. Each camera module includes a VCM actuator (respectively 108a, 108b) coupled to a lens barrel (respectively 110a, 110b), which needs to be actuated (shifted) in the Z direction to focus an image. The camera modules may have identical dimensions, for example identical lengths and heights (in respectively the X and Z directions, FIG. 1a) or non-equal dimensions. The lens barrel is held in a lens carrier (respectively 112a, 112b) on which a coil (respectively 114a, 114b) is wound. For control, the lens carrier is typically hung by a spring on a static body (neither of them shown). Four static permanent magnets (respectively 116a-d and 116′a-d) are positioned on the four corners of each VCM actuator.

The lens barrel in each camera module may be actuated by passing current through the coil (clockwise direction in FIG. 1d) via the Lorentz force. The Lorentz force is known to be equal to:

F=NI∫\vec{B}×d\vec{l} (1)

where N is the number of windings, I is the current in the coil, and d\vec{l} is a wire element. Thus, only a magnetic field perpendicular to the wire creates force in the motion direction (Z direction). The Lorentz force pushes the wire (and thus the lens carrier and the lens barrel) in the +Z direction. Each camera module is surrounded by a thin exterior rectangular mechanical shield (respectively 118a, 118b). Each mechanical shield may be used to protect the module from dust, to serve as mechanical stop for the lens shift, to reduce stray light from reaching the camera sensor (not shown), etc. A shield 118 does not serve as an effective magnetic shield for the VCM actuator magnets.

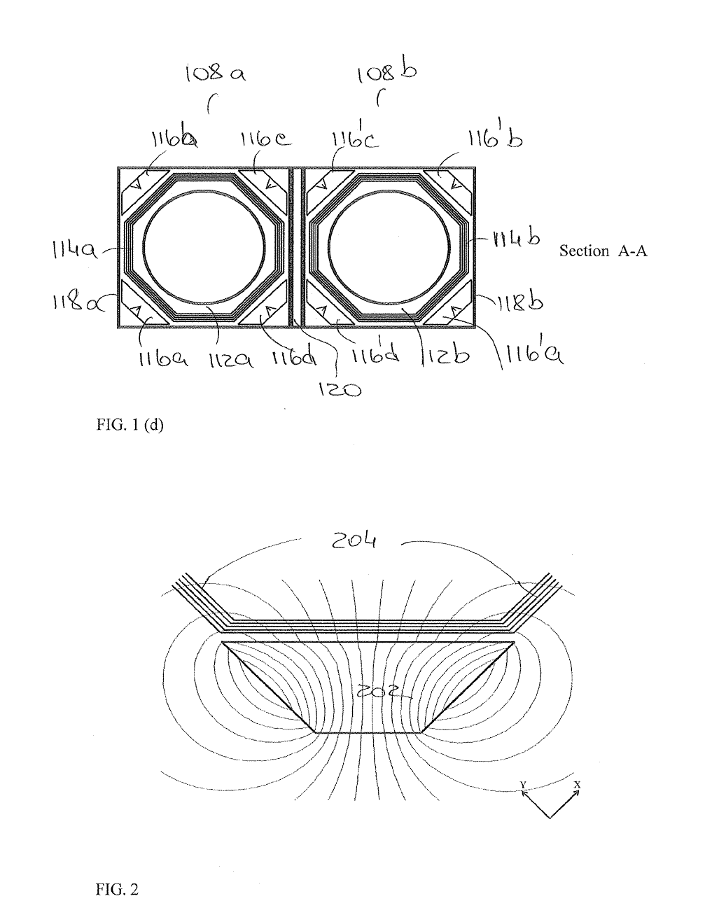

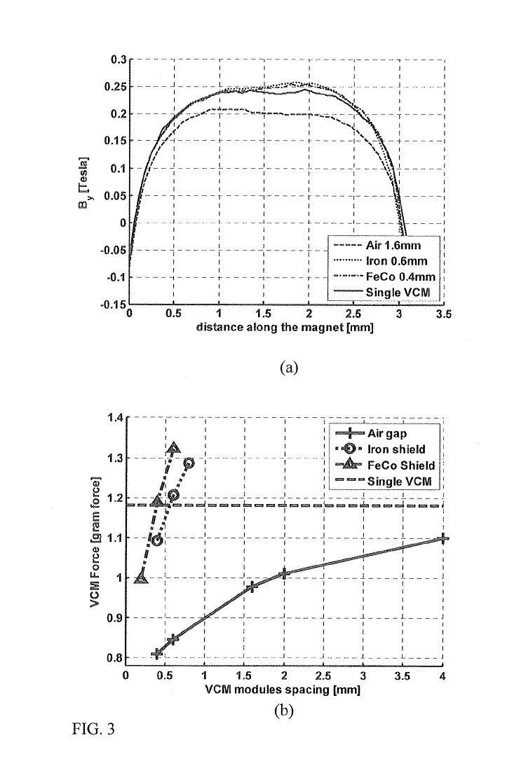

In order to reduce the magnetic coupling of the two modules, a magnetic shield in the form of a plate 120 with thickness “d” is positioned permanently during the module assembly stage between the two VCM actuators. The plate may be made of any ferromagnetic material. Specifically, in an embodiment, the plate may be made of grey iron. In another embodiment, the plate may be made of a FeCo alloy. In another embodiment, the plate may be made of a FeNi alloy (Permalloy). In some embodiments, plate 120 may be rectangular and dimensioned so that its length “l” and height “h” are not larger than those of a camera module. In an embodiment in which the two camera modules are not identical, plate 120 may be rectangular and dimensioned so that its length and height are not significantly larger than those of the larger camera module. This assures maximal magnetic field shielding, while keeping the total camera module pair length and height unchanged. Thickness d is kept as thin as possible while keeping the magnetic functionality of the VCM intact. Simulations presented in FIGS. 3 (a), (b) show that a thickness d of 0.4-0 6 mm (depending on the magnetic properties of the material it is made from) fulfills this condition. Plate 120 may be glued tightly to the two camera modules to leave no gap between the plate and each camera module. FIG. 2 shows flux lines of a typical known art trapezoid VCM magnet 202 calculated using FEM software. The flux lines trajectories and their direction correspond to a coil 204.

Returning now to FIG. 3, simulations were run on four configurations (“cases”) in order to estimate the force change in the dual aperture module: (1) two

VCM actuator separated by an air gap d and without a magnetic shield plate; (2) two VCM actuators with a magnetic shield plate disclosed herein inserted therebetween, the plate made of grey iron and having a thickness d; (3) two VCM actuators with a magnetic shield plate disclosed herein inserted therebetween, the plate made of FeCo and having a thickness d; and (4) a single VCM actuator. The goal of the simulations is to show that the force in the presence of the magnetic shield plate is similar to the force in the single VCM actuator case.

FIG. 3(a) shows the simulation results for the magnetic field Bi perpendicular to the coil. FIG. 3(b) shows the simulation results for the Lorentz force calculated using the amplitude of magnetic field Bi and equation 1. The simulations (all four cases) used typical values for VCM actuators: a VCM footprint of 8.5×8.5 mm², four magnets places in the four corners of the VCM, the magnets having isosceles trapezoid shape (bases length 1.2 mm and 3.2 mm, and angles of 45° and 135°) and being made from neodymium, a wire having a regular octagon shape with sides of 3.4 mm and N=50 winding, current in the wire I=80 mA, and distance from wire to magnet of 100 μm (see the VCM design FIG. 1(d)) . The distance between the two VCM actuators (cases 1-3) and the magnetic shield thickness (cases 2, 3) was varied and results compared to the case of the single VCM (case 4). One can see that without a magnetic shield (1), the total force inflicted by the magnet on the wire is smaller than in the case of a single VCM (case 4) even for a 4 mm air gap. A magnetic shield (cases 2-3) with sufficient thickness preserves the same force as a single VCM (case 4). The sufficient thickness (d) depends on the shield material: for grey iron it is approximately 0.6 mm, while for FeCo it is 0.4 mm In other words, a magnetic shield between two VCM actuators as described herein can reduce the distance between the camera modules from more than 4 mm to 0.4 mm.

While this disclosure has been described in terms of certain embodiments and generally associated methods, alterations and permutations of the embodiments and methods will be apparent to those skilled in the art. For example, dual aperture cameras with non-VCM type magnetic actuators with permanent magnets may also benefit from use of a magnetic shield as disclosed herein. The disclosure is to be understood as not limited by the specific embodiments described herein, but only by the scope of the appended claims.

1. A dual-aperture camera comprising:
a) a first camera module including a first voice coil motor (VCM) actuator coupled to a first lens barrel, the first VCM actuator operable to change a position of the first lens barrel in a given direction;
b) a second camera module including a second VCM actuator coupled to a second lens barrel, the second VCM actuator operable to change a position of the second lens module in the given direction; and
c) a magnetic shield plate fixedly positioned between the first and second camera modules, whereby the magnetic shield plate shields magnetically each VCM actuator from magnetic interference by the other VCM actuator during operation.

2. The dual-aperture camera of claim 1, wherein the first and second camera modules have identical lengths and heights and wherein the plate has a length and a height no greater than the camera modules length and height.

3. The dual-aperture camera of claim 1, wherein the first camera module has a larger length and a larger height than the second camera module and wherein the plate has a length and a height no greater than the first camera module length and height.

4. The dual-aperture camera of claim 2, wherein the magnetic shield plate has a thickness d between 0.4-0.6 mm.

5. The dual-aperture camera of claim 3, wherein the magnetic shield plate has a thickness d between 0.4-0.6 mm.

6. The dual-aperture camera of claim 2, wherein each camera module length is between 5-15 mm and wherein each camera module height is between 3-12 mm.

7. The dual-aperture camera of claim 3, wherein the first camera module length is between 5-15 mm and wherein the first camera module height is between 3-12 mm.

8. The dual-aperture camera of claim 2, wherein each camera module length is between 8-10 mm and wherein each camera module height is between 3-6 mm.

9. The dual-aperture camera of claim 3, wherein the first camera module length is between 8-10 mm and wherein the first camera module height is between 3-6 mm.

10. The dual-aperture camera of claim 2, wherein each camera module length is between 8-10 mm and wherein each camera module height is between 4-8 mm.

11. The dual-aperture camera of claim 3, wherein the first camera module length is between 8-10 mm and wherein the first camera module height is between 4-8 mm.

12. The dual-aperture camera of claim 4, wherein each camera module length is between 5-15 mm and wherein each camera module height is between 3-12 mm.

13. The dual-aperture camera of claim 5, wherein the first camera module length is between 5-15 mm and wherein the first camera module height is between 3-12 mm.

14. The dual-aperture camera of claim 2, wherein the shield plate includes a material selected from the group consisting of grey iron and FeCo.

15. The dual-aperture camera of claim 3, wherein the shield plate includes a material selected from the group consisting of grey iron and FeCo.
